(19) United States
(12) Patent Application Publication
(10) Pub. No.: US 2011/0184714 A1
(43) Pub. Date: Jul. 28, 2011

(54) Methods and Systems for Analyzing Electronic Design and Validation Models

(75) Inventors: Eugene Zhang, Los Altos Hills, CA (US); Xiaopeng Qiu, Beijing (CN); Andrea Kroll, Santa Clara, CA (US); Ming Zhong, Beijing (CN)

(73) Assignee: JEDA TECHNOLOGIES, INC., Santa Clara, CA (US)

(21) Appl. No.: 13/014,704

(22) Filed: Jan. 26, 2011

Related U.S. Application Data
(60) Provisional application No. 61/298,538, filed on Jan. 26, 2010.

(51) Int. Cl. G06F 17/50

(52) U.S. Cl. 703/13

(57) ABSTRACT

A method and system for comparing a first model and a second model of an electronic design, wherein the first model is at a transaction level and the second model is at a register transfer level, comprises the steps of: translating signal values of the second model to a transaction stream; comparing a transaction stream of the first model against the transaction stream of the second model based on data at timing points of transaction phases of the transaction streams; and generating results based on the comparison of the transaction streams.

### CROSS REFERENCE

This application claims priority from a provisional patent application entitled “Using Filters And Rules to Compare Models at Different Levels of Abstractions For Transaction Streams” filed on Jan. 26, 2010 and having an Application No. 61/298,538. Said application is incorporated herein by reference.

### FIELD OF INVENTION

This invention relates to methods and systems for analyzing electronic design and validation models and, in particular, to methods and systems for comparing and validating electronic design and validation models at various levels of abstraction.

### BACKGROUND

Abstraction techniques are used in high level property checking of digital circuits. A transaction is a discrete operation on a signal level, e.g., writing one or more bytes from a central processing unit (“CPU”) to memory. Models for processing transactions, operating at different levels of abstraction, may be used by a system designer in designing and testing system blocks. The design of a system block may initially be tested using a transaction model, such as a transaction level modeling (“TLM”) model.

In addition, the design of the system block may be tested and validated at lower levels of abstraction, e.g., via a register transfer level (“RTL”) equivalent model. At the register transfer level, clocks and registers are one hundred percent accurately specified, where clock-cycle by clock-cycle value changes at all registers in the design are specified.

TLM models abstract from the cycle by cycle behavior of the hardware and focus on value transfers between components. For example, a system on a chip (“SoC”) includes components in TLM models of memory, interconnects, a processor, direct memory access (“DMA”) controllers, peripherals and/or accelerators. Its functionality and hardware timing behavior is abstracted such that data throughput constraints between components as well as the time needed to send and process data is still present. Here, the clock-cycle by clock-cycle behavior of the targeted SoC with respect to its internal registers is not one hundred percent accurately represented in the TLM model, also known as electronic system level (“ESL”) model. By definition, TLM models lack certain details of lower RTL models. There are also multiple types of TLM models of different accuracy levels for various applications, such as system performance analysis and software development.

Due to the rising complexity of SoC designs, designers are using higher levels of abstractions above RTL to specify a SoC. The designers need to specify the targeted hardware accurately enough to accomplish system throughput and latency analysis as well as develop software for the SoC.

A problem not addressed by the current technological art is that a TLM/ESL model developer needs to verify that the model represents the targeted SoC accurately enough so that the analysis results are the same for the TLM/ESL model and the final product. The developer also needs to ensure that the executable developed by the software developer runs in the same way on the TLM model and on the final product.

There are tools available, which are used to compare RTL with models at higher levels of abstraction. The goal of those tools is to verify the functionality of the RTL and not the model at higher levels of abstraction. Timing information of the higher level model is not taken into account. Furthermore, verification of the timing of the RTL model is done using temporal assertions manually written by the user. None of the tools for the RTL model operate at a TLM level, specifically using transaction phases.

Products like SLEC from Calypto Design Systems is one representation of an equivalence checker checking the sequential equivalence of an RTL model with a functional model using formal techniques. SLEC uses formal methods and does not use simulation or simulation traces. It is known in the art that simulation and simulation traces are fundamentally different from formal methods. Therefore, it is desirable to provide methods and systems for analyzing various models at different levels of abstraction for an electronic design.

### SUMMARY OF INVENTION

An object of this invention is to provide methods and systems to ensure that electronic design and validation models (“models”) at higher levels of abstraction capture the targeted hardware within a certain level of acceptable accuracy.

Another object of this invention is to provide methods and systems for using definable filters and rules to specify a level of acceptable accuracy for one or more models.

Yet another object of this invention is to provide methods and systems for analyzing various models at different levels of abstraction.

Briefly, the present invention relates to a method and system for comparing a first model and a second model of an electronic design, wherein the first model is at a transaction level and the second model is at a register transfer level, comprising the steps of: translating signal values of the second model to a transaction stream; comparing a transaction stream of the first model against the transaction stream of the second model based on data at timing points of transaction phases of the transaction streams; and generating results based on the comparison of the transaction streams.

An advantage of this invention is that methods and systems are provided to ensure that electronic design and validation models at higher levels of abstraction capture the targeted hardware within a certain level of acceptable accuracy.

Another advantage of this invention is that methods and systems for using definable filters and rules to specify a level of acceptable accuracy for a model are provided.

Yet another advantage of this invention is that methods and systems for analyzing various models at different levels of abstraction are provided.

### DESCRIPTION OF THE DRAWINGS

The foregoing and other objects, aspects, and advantages of the invention will be better understood from the following detailed description of the preferred embodiment of the invention when taken in conjunction with the accompanying drawings in which:

FIG. 1 illustrates a work flow diagram of a transaction analyzer of the present invention for analyzing two models.

FIG. 2 illustrates a work flow diagram of a transaction analyzer of the present invention for analyzing one model.

FIG. 3 illustrates a data flow for using a VCD dump file to generate a transaction analyzer database of the present invention.

FIG. 4 illustrates a mechanism to use a SCV file to generate a transaction analyzer database.

FIG. 5 illustrates a view of a transaction stream of the present invention.

FIG. 6 illustrates a view of a transaction stream, where phases belonging to the same transaction are identified by a connecting line connected to those phases.

FIG. 7 illustrates a user interface of the transaction analyzer and a view of a transaction stream, where VCD information is mapped to the transaction phases of the transaction stream.

FIG. 8 illustrates a view of multiple sequences combined into a single transaction stream.

FIG. 9 illustrates a transaction stream of the present invention, where a sequence filter is defined and applied to the transaction stream.

FIG. 10 illustrates a resulting display of transaction streams, where a performance filter was applied on the transaction streams

FIG. 11 illustrates a user interface where a transaction stream is displayed on the user interface.

FIG. 12 illustrates a user interface of the present invention that allows a user to select from a list of applicable filters to be applied to one or more transaction streams.

FIG. 13 illustrates a user interface of the present invention, where a configuration widget is displayed such that a user can specify parameters for a margin of difference or an inaccuracy percentage rate.

FIG. 14 illustrates a user interface, where a result is printed and the first pair of phase violations is identified.

### DETAILED DESCRIPTION OF THE PREFERRED EMBODIMENTS

The present invention relates to automation of the verification process by providing means to identify incorrectly specified TLM/ESL models with respect to transaction phase sequences, timing, functionality and/or performance. One or more models under test at a higher level of abstraction and a reference model at a lower level of abstraction can be compared to determine any discrepancies between the models. An allowed discrepancy between the models can be user-defined (or otherwise predefined) such that an error is not flagged. In addition to discrepancies, a user can also review the order and timing of transaction phases of the models and get additional information about the values transmitted per transaction phase from the models. Thus, performance, timing, and functional accuracy of the model under test in comparison with the reference model (or user's expectations) can be obtained. Furthermore, after the initial analysis and specification step, a checker can be generated that checks automatically for unacceptable inaccuracy in the model under test. The checker can also be integrated within a TLM/ESL model.

Various rules and filters can be applied such that the two (or more) electronic design and validation models can be equivalent under certain rules or filters, and at the same time, be unequal under different rules and filters. The rules and filters can be applied on the transaction streams to gauge the performance, timing, sequence, and functionality of the models. Additionally, the rules and filters can also be configurable by a user or predefined to adjust the parameters of the rules and filters.

The analysis of the models at various levels of abstraction can either operate on a post-processing way, where one or more rules and/or filters are applied to simulation traces from the models. In addition, the rules and/or filters can be applied dynamically during simulation execution of the models. It is important to note that the following examples are in reference to analyzing two models; however, the present invention can be applied to analyzing any number of models by comparing transaction streams of the models.

In alternative embodiments, rules and filters can also be applied to only one model for validation purposes of that model.

In an embodiment of the present invention, two models can be analyzed at the transaction level (“TL”) abstraction using rules and filters related to system performance (i.e., bandwidth, latency, throughput) and transaction sequence ordering. The transaction streams can be used in post-simulation trace dumps or in run-time simulation executions. One model can be at the TLM, i.e. a high level, and the other can be typically at the RTL, i.e. a lower level than the TLM.

The analysis is performed with respect to data values at the timing points of transaction phases. A transaction comprises multiple sub-transactions called transaction phases. Transaction phases are unidirectional transmission of data or control information to ensure a save data transmission between two or more components. One or more transaction phases can be used to build a single transaction.

Configurable filters and rules are used to specify the expected performance, functionality and timing accuracy of the higher level model. A transaction analyzer (“TL analyzer”) uses all or a subset of filters and rules to generate checkers. The checker can be integrated with the high level model to automatically check for sequence, performance, and timing violations. A key difference to previous approaches is that the comparison of performance, functionality, timing and sequences can be done at the higher level of abstraction (e.g., at the TLM model) by raising the level of abstraction of the lower level model (e.g., the RTL model), rather than adding more details to the higher level model and comparing the models at the lower level. A model's accuracy can be determined via timing, throughput, and function information to reach a quantitative percentage number. Also, checkers can be selected from filters and applied to simulation runtime of the models. Various transactions and transaction phases can also be displayed and grouped together. Additionally, one or more individual streams can be filtered and the result displayed on a user interface (“UI”).

In various embodiments of the present invention, the following mechanisms can include, but are not limited to, the following: (a) transaction streams of a TLM model from a simulation are captured and stored in a database, where only data at timing points of transaction phases are stored; (b) for an RTL model, a generator of the transaction analyzer can be used to translate from a lower RT level trace to a TLM trace, where the translated TLM trace is then stored in the database; (d) the streams and the TLM trace are stored in memory; (e) the filters and checkers can be applied during a simulation run-time; (f) time stamps of transaction phases can be used as points of measurement for comparison; and (g) one or more models can be compared using timing filters, performance filters, sequence filters, and functional filters.

### Work Flow for Analyzing One or More Models at Various Abstraction Levels

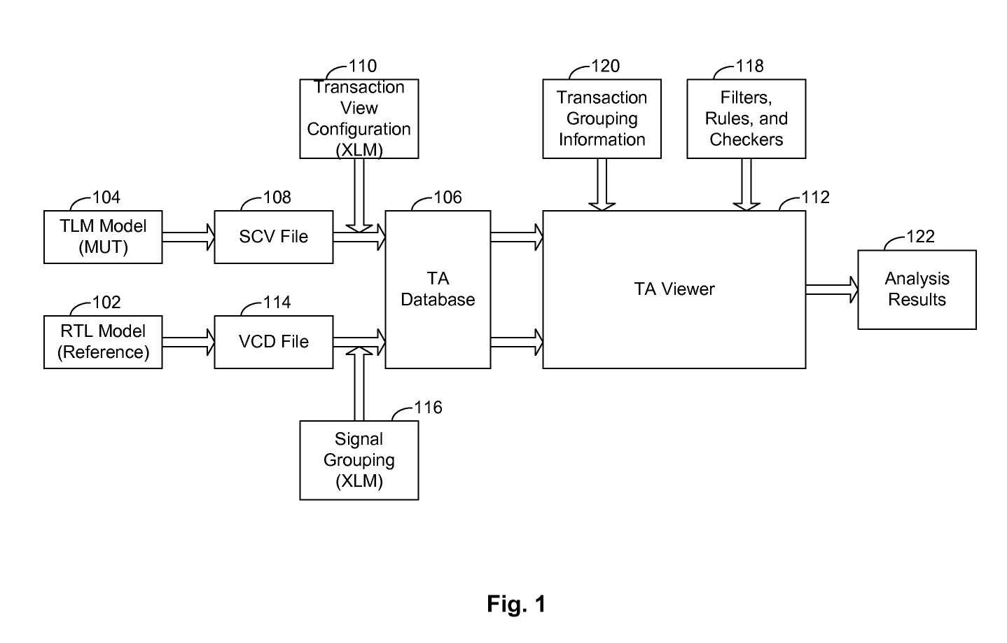

FIG. 1 illustrates a work flow diagram of a TL analyzer of the present invention for analyzing two models. A TL analyzer can be used for comparing two or more models, e.g., a reference model, typically in RTL, and a model under test (“MUT”) model, typically at a higher level of abstraction. The TL analyzer generally compares two or more models by representing the models in transaction streams and comparing the transaction streams.

For a TLM model 104, a transaction stream is stored in a transaction database, TA DB, 106. One possible format for the transaction stream can be in a SystemC Verification Library (“SCV”) file 108 defined by Open SystemC Initiative (“OSCI”). In a transaction view configuration file 110, the user can redefine how the transactions are viewed in the transaction viewer, TA viewer, 112. For instance, the user can define the name of the transaction phases displayed in the transaction viewer 112 and can define attributes used for the transaction comparison with the reference model. The attributes for transaction phases can include various information of the phases, including, but not limited to, timestamps, thread id numbers, transaction types, respective command, address, data length, transaction phase name, response status, DMI information, debugging information, byte enable array, and user defined information.

For an RTL model 102, a signal value over time is captured. One possible format is in a value change dump (“VCD”) file 114 format. Together with predefined definition(s) for signal groupings 116, the signal values can be combined into a transaction and transaction phases. In addition, control signals indicating the start of the transaction phase can also be converted from the VCD file 114 to the TA DB 106. In summary, the TA DB 106 is a transaction level database including data at timing points of transaction phases.

After generating the TA DB 106, the user can view the transaction in the TA viewer 112. Here, the user can select the transactions and merge two or more transaction streams into a single transaction stream to be stored in the TA DB 106. Transaction streams can be merged into the single transaction stream by having the transactions plotted on a single time axis. Filters, rules and checkers 118 can be applied to anyone of the streams, including individual transactions stream and the merged transaction stream. In addition, the user can configure or predefine the filters, rules, and checkers.

Using the information in TA DB 106 and transaction grouping information 120, as well as the filters 118, the TL analyzer executes the filters and identifies transaction violations (if any) which do not meet the specified criteria defined in the filter specification. Transaction grouping information is used to separate transactions into several groups. Transactions in the same group may have one or more common attributes or common relationship. For instance, transactions in a transaction group may all have been dumped by the same module. The analysis results 122 can be displayed on a user interface.

Rule checkers can also be generated based on all or a subset of the filter specification. The rule checkers can be integrated with the high level model to automatically detect abstraction violations in terms of timing, performance and functionality in real execution time.

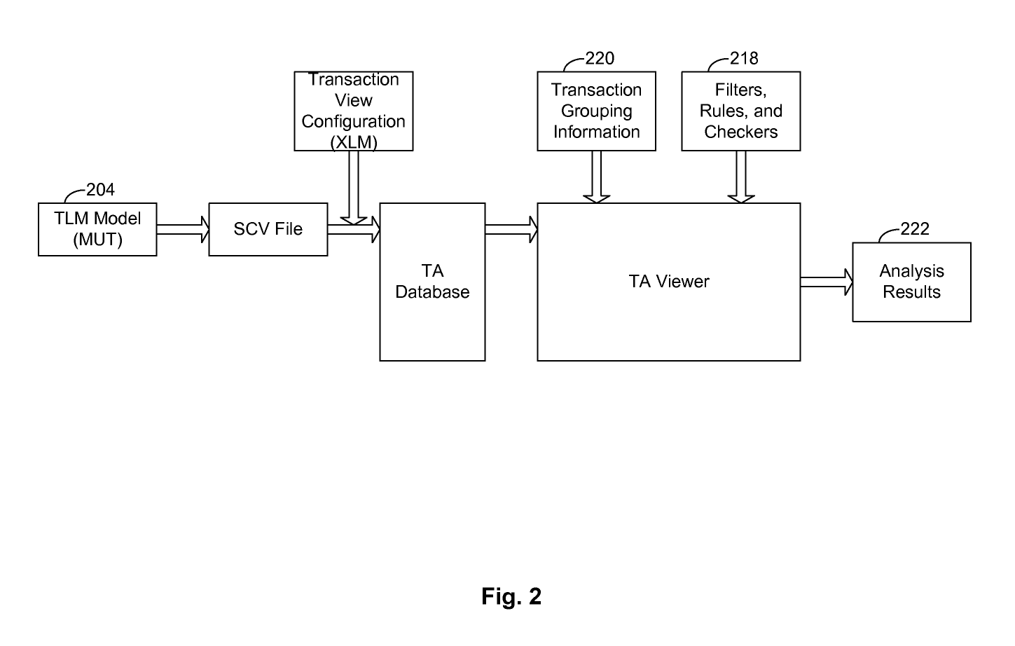

FIG. 2 illustrates a work flow diagram of a TL analyzer of the present invention for analyzing one model. Here, a single model 204 is analyzed. The TL analyzer can apply filters and rules 218 and transaction grouping information 220 directly to one or more streams from the single model 204 (unlike in FIG. 1 where the filter, rules, and transaction grouping information may be applied to a combination of streams from various models). The TL analyzer executes the filters and identifies transaction violations (if any) which do not meet the specified criteria defined in the filter specification. The analysis results 222 can be displayed on a user interface.

Generating a Transaction Stream from Signal Value Changes of an RTL Model

During the respective model simulation, the information about signal values over time is captured. A VCD is a commonly used format for RTL. A signal data stream can come from a sc signal in SystemC, an RTL signal, or a hardware trace from HW, FPGA, or an emulation system. Information about value changes over time either for input/output ports or internal states of the respective electronic design are captured. A TA tool provides a conversion step, which translates the information captured from the signal trace into a transaction stream and stores it in the TA DB so that it can be processed and viewed by the TL analyzer.

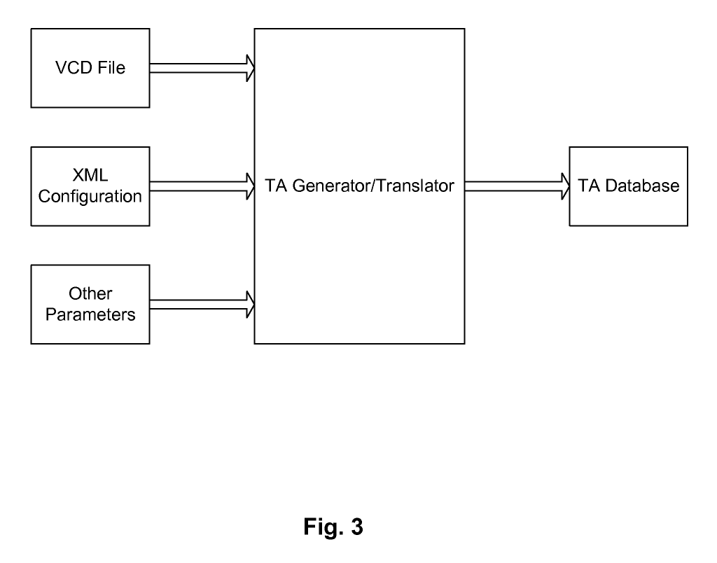

FIG. 3 illustrates a data flow for using a VCD dump file to generate the TA DB. A TA generator/translator's input is the VCD file, a protocol specification (which is in XML format), and other parameters; its output is the corresponding TA DB. The TA generator groups signals and values into transactions based on the protocol specification.

Generating a TA Database from a TLM Model

For TLM traces, SCV (as defined under OSCI and can be found at www.systemc.org) offers a recording mechanism that allows for recording information in a predefined database format. For a TLM model, the recording engine is inserted into the data stream to capture information from the TLM model function calls.

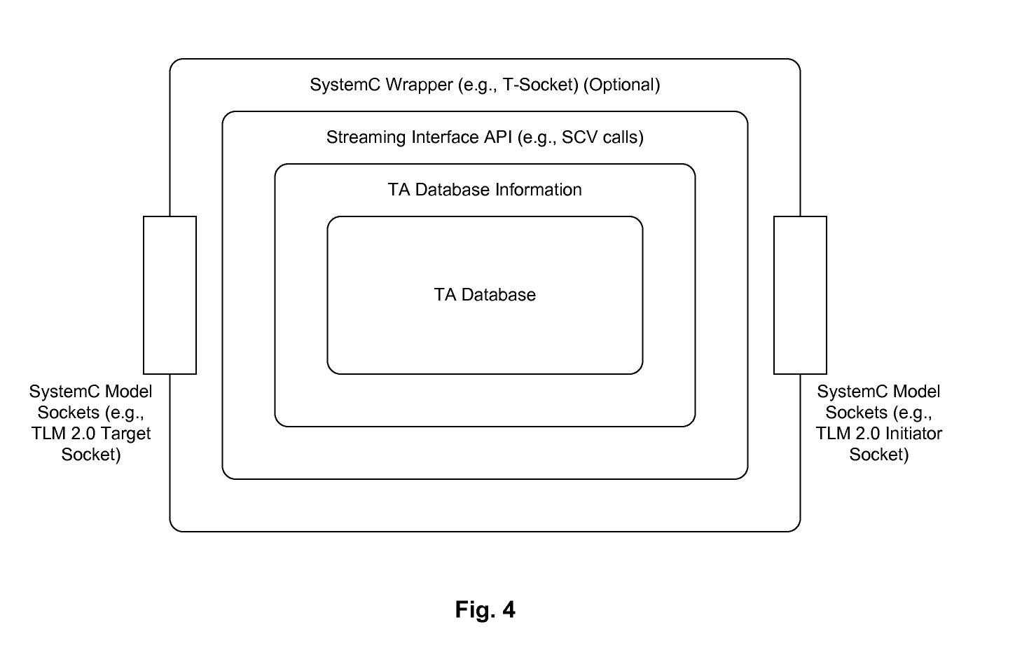

FIG. 4 illustrates a mechanism to use a standard SCV to generate a transaction analyzer database. A SystemC wrapper (optional) is used as sockets to connect two TLM modules. In this wrapper, streaming interface API, possibly based on an SCV API, is called to transfer transaction information to the TA DB handler. The TA DB handler then stores the transaction information in the TA DB.

### Displaying the Transaction Information by the Transaction Analyzer

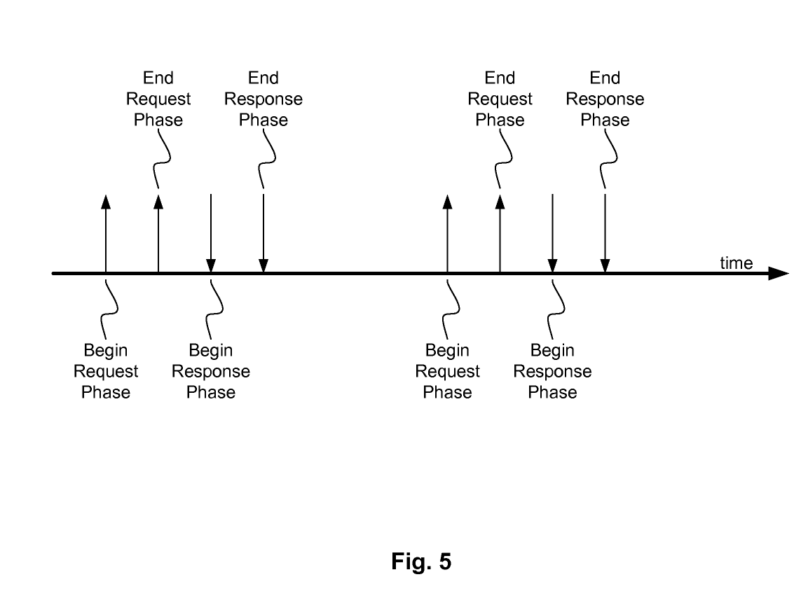

FIG. 5 illustrates a view of a transaction stream of the present invention. An abstracted view of a transaction can illustrate transaction phases and related information. Here, a TLM2.0 Base Protocol AT model with 4 phases is displayed along an axis, where the axis of the transaction corresponds to time. Each transaction phase can be drawn as a line, arrow, or other symbol to indicate the timing information of the transaction phase (e.g., when it starts). Different phases can be displayed by different colors and/or with different symbols, such that each phase can be visually distinguishable from each other. The abstracted view of the transaction stream and the associated information of the transaction stream can be displayed on a user interface. Unlike other commercial viewers for VCD or transactions, the transaction analyzer of the present invention can display an abstracted view using transaction phases and their sequential dependencies.

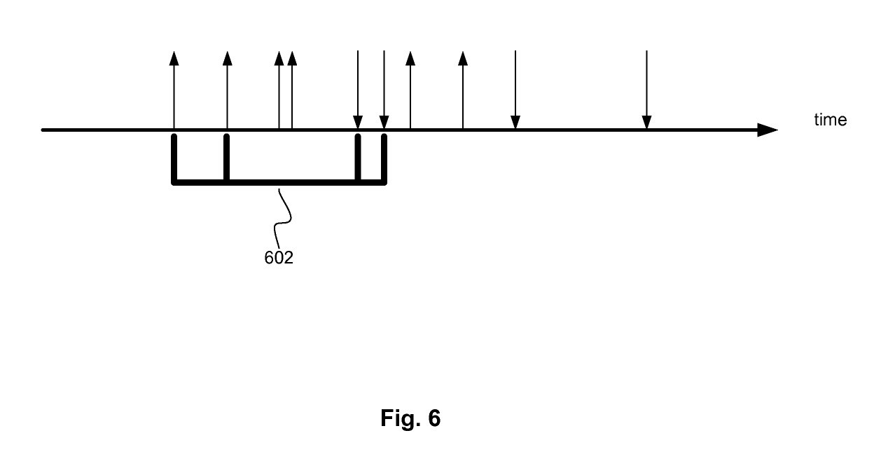

FIG. 6 illustrates a view of a transaction stream, where phases belonging to the same transaction are identified. To identify all the transaction phases of a transaction, one of the transaction phases of that transaction can be selected (e.g., by a mouse click or other identifying action) to initiate the search. Once initiated, all of the transaction phases belonging to that respective transaction can then be identified by displaying a connecting line 602 to the transaction phases of that respective transaction. In addition, the transaction phases can be identified by other methods, such as highlighting the display of the transaction phases, listing the transaction phases, or other methods to display the information that the transaction phases all belong to the respective transaction.

When a transaction phase is selected, the following information about the full transaction can also be displayed: number of phases of the transaction; name of each phase; timing of each phase; order of the phases, if applicable; and additional attribute information of the transaction.

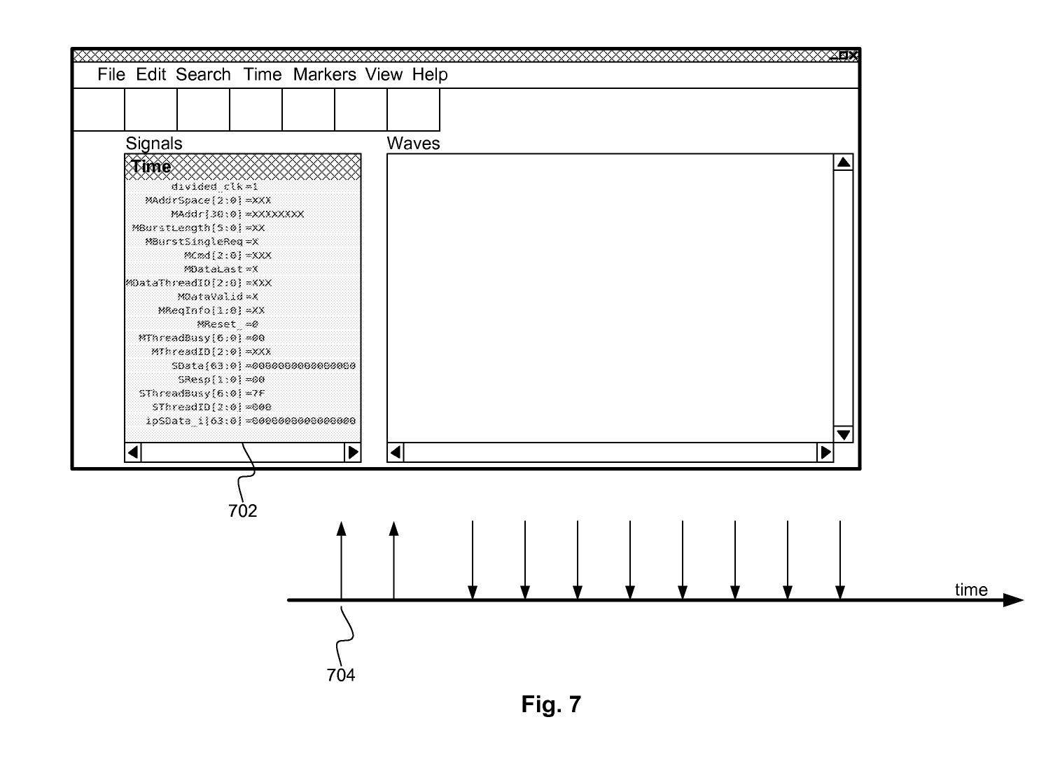

FIG. 7 illustrates a user interface of a transaction analyzer and a view of a transaction stream, where VCD information is mapped to the transaction phases of the transaction stream. The results of the VCD information 702 can be mapped to transaction phases on a transaction stream 704. The TL analyzer can also display the cross reference of a standard VCD viewer and its converted TA viewer.

### Transaction Analysis

The TL analyzer provides a set of user configurable and predefined filters. The filters are applied to the selected transaction streams in the TA DB. Filters can be used for transaction analysis to obtain information pertaining to timing comparison, sequential analysis, performance comparison, and functional analysis. The results of applying the filters can be displayed in the TA viewer.

### Timing Filters (Timing Analysis)

Timing filters concentrate on comparing the timing of the transaction phases. The timing filters are designed such that they detect discrepancies between the times of the transaction phases from the higher level model and the transaction phases from the lower level model. Timing filters can have predefined parameters. The following list describes some examples of timing filters:

1. All Phase—Timing Filter

An all phase filter compares the timing of all transaction phases for two or more models, and flags any difference in the timing as an error. It can be assumed that the transaction from the lower level model and the higher level model are received in the same order. Thus, any out of order execution or additional RTL and TLM transactions are flagged as an error.

2. First Phase—Timing Filter

A first phase filter compares the timing of a first phase of a data transfer and flags an error if the respective first phase of the data transfer is sent at different times for the two or more models. The first phase filter can ignore the timing of other phases and assumes in-order processing. Thus, any out of order execution or additional RTL and TLM transactions are flagged as an error.

3. Last Phase—Timing Filter

A last phase filter compares the timing of a last phase of a data transfer and flags an error if the last phase of the data transfer is sent at different times for two or more models. The last phase filter can ignore the timing of any other previous phases for that respective transaction and assumes in-order processing. Thus, any out of order execution or additional RTL and TLM transactions are flagged as an error.

4. First and Last Phase—Timing Filter

A first and last phase filter compares the timing of a first and a last phase of a data transfer and flags an error if either the first phase or the last phase of the data transfer is sent at different times for two or more models. It ignores the timing of any other phase for that respective transaction and assumes in-order processing. Thus, any out of order execution or additional RTL and TLM transactions are flagged.

5. Reference Phase—Timing Filter

A reference phase can be specified with a name, an order number, or to a list of phases. The reference phase filter can flag an error if any specified reference phase is sent at a different time for two or more models. It can ignore the other phases not specified as the reference phase and assumes in-order processing. Thus, any out of order execution or additional RTL and TLM transactions are flagged as an error.

6. Fixed Acceptable Delay with Reference Phase—Timing Filter

A predefined delay and a reference phase with a name or an order number can also be specified. If a reference phase is not specified, then a first phase can be taken as the default reference phase. This filter compares the timing of all predefined phases of a data transfer and flags an error if any of the predefined phases is transmitted at a different time than the RTL transaction plus a predefined latency. A positive or negative latency number can be specified. For instance, a symbol “+−” can be inputted on a command line for the user interface to mean that the filter accepts both. In-order processing can be assumed for this filter. Thus, any out of order execution or additional RTL and TLM transactions are flagged as an error.

7. Max Delay in Order—Timing Filter

A predefined maximum delay allowed and a reference phase with a name or an order number can be specified. If a reference phase is not specified, then a first phase can be taken as the default. The max delay in order filter compares the timing of all predefined phases of a data transfer and flags an error if any of the predefined phases are transmitted later than the RTL transaction plus a predefined latency. The user can specify a positive or negative latency number. For instance, a symbol “+−” can be inputted on a command line for the user interface to mean that the filter accepts both. In-order processing can be assumed for this filter. Thus, any out of order execution or additional RTL and TLM transactions are flagged as an error. If the user does not specify any latency this means that the tool only flags those transactions, which are executed out of order.

8. Max Delay Out of Order—Timing Filter

A predefined maximum delay allowed and a reference phase with a name or an order number can be specified. If a reference phase is not specified, then a first phase can be selected as the default reference phase. The max delay out of order filter compares the timing of all predefined phases of a data transfer. An error is flagged if any of the predefined phases is transmitted later than the RTL transaction plus a predefined latency. The user can specify a positive or negative latency number. For instance, if a TLM model and a RTL model are compared, than a positive latency can mean that the TLM phase comes after the RTL phase. A negative latency can mean that the TLM phase comes before the RTL phase.

If the user inserts a symbol “+−” in front of the latency specification in a command line for the user interface, this can mean that the filter accepts both, i.e., an RTL phase before the TLM phase and a TLM phase before an RTL phase. It is not assumed that the transactions in the RTL and in the TLM are received in the same order. Thus, out of order execution is only flagged when the timing delay of a transaction exceeds the predefined delay.

### Sequence Filters (Sequence Analysis)

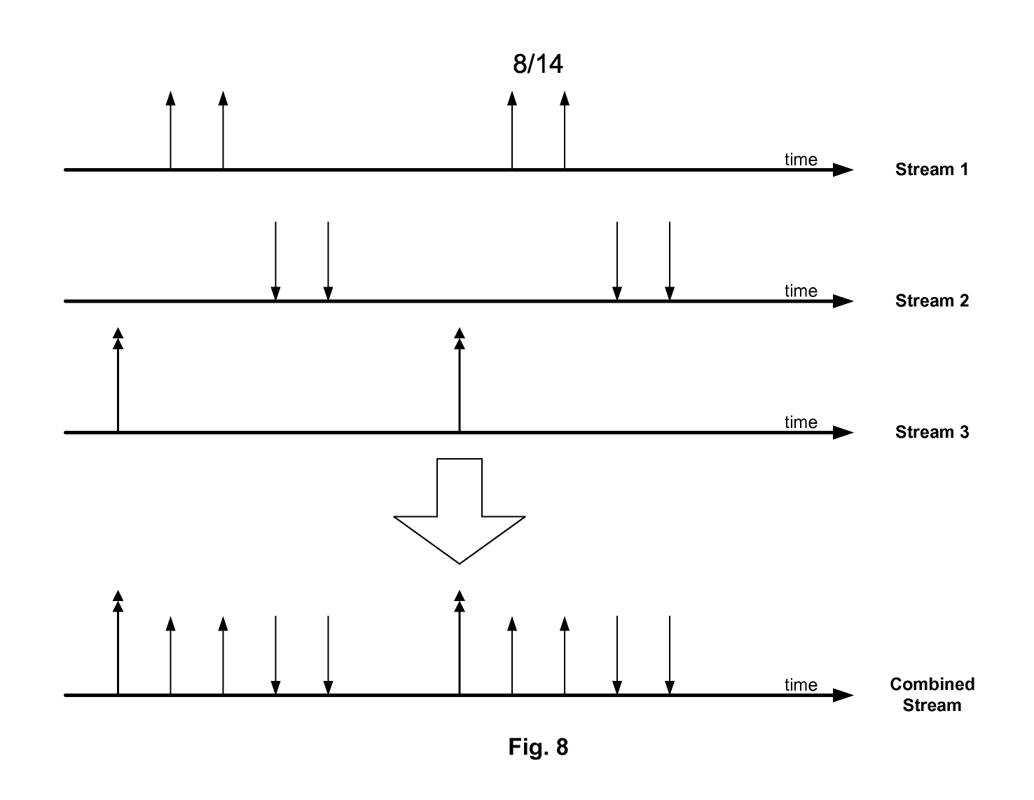

Besides timing filters, expected sequences of transactions and transaction phases over the course of a simulation can be specified. Typically, one or multiple traces from the same model are combined into one transaction stream. FIG. 8 illustrates a view of multiple traces combined into a single transaction stream. Here, the timing information of the transaction phases from multiple traces is combined along a single time axis to form a single transaction stream. (Note, the multiple traces and/or streams can be merged from the same model and/or different models.) After the traces are combined, the sequence filters can be applied to the combined transaction stream. A list of possible sequence filters is provided below.

1. Predefined Sequence Filter

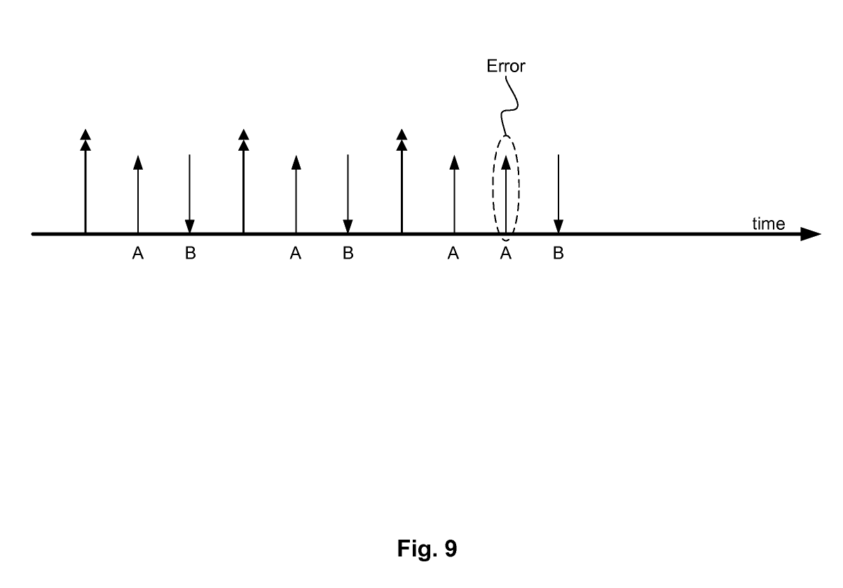

FIG. 9 illustrates a transaction stream of the present invention, where a sequence filter is defined and applied to the transaction stream. A user may need to specify an expected sequence of transactions or transaction phases. A sequence can be defined for a number of sequences or span an unlimited number of sequences until a transaction stream does not follow the sequence. For example, a user can input (−1, A) followed by (0, B) to specify that A and B phases should alternate in a sequence in a transaction stream. When the sequence of the transaction stream does not follow this order, then the error is flagged and an alert (e.g., a message or the sequence violation highlighted) can be displayed to the user. For instance, if the sequence of the transaction stream is A, B, A, B, A, A, then the last A is flagged as an error since two A's follow each other in the sequence along the transaction stream.

2. Sequence Specification with Attribute Value

It can be assumed that a user may want to specify something like every write to any address may need to be followed by a write to a selected address. The user can specify attribute names with specific expected values, where the values can be predefined or user specified.

3. Account for Outstanding Transactions

A maximum number of outstanding transactions can be identified. For example, an interrupt that is followed by a maximum of N read transactions may need to be determined. Thus, the user needs to be able to specify the maximum number of transactions, transaction phases and transaction phases with specific attribute values, before the filter starts flagging the illegal transactions.

### Performance Filter

The purpose of the performance analysis is to compare the throughput and latency performance of transactions from a lower level model and transactions from a higher level model. The user can define the margin of difference that the comparison should tolerate.

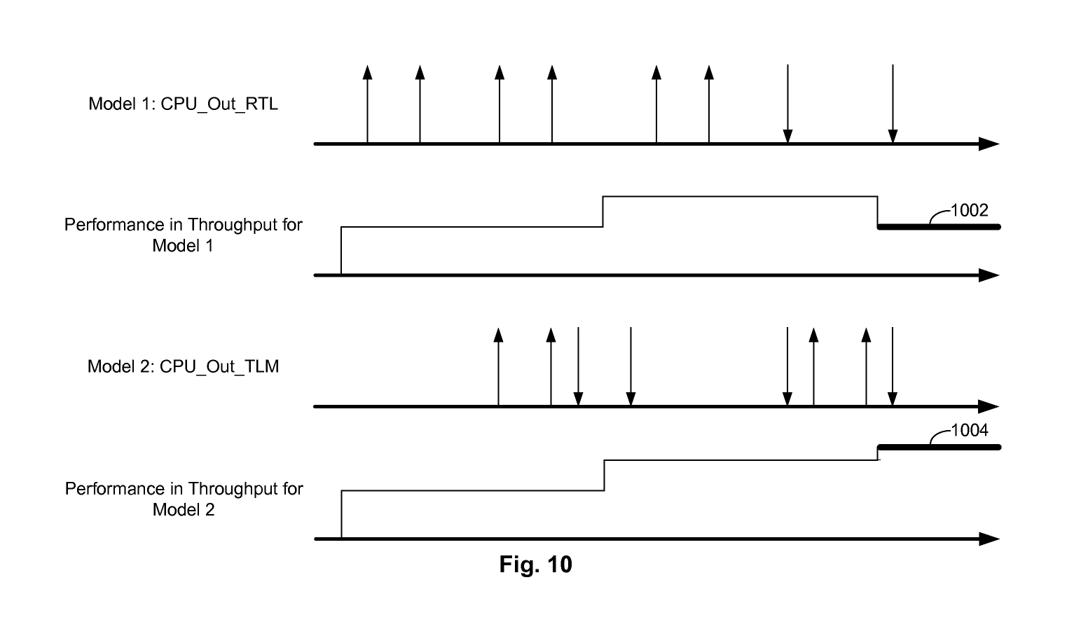

For the throughput performance filter, the user can also specify the timing window to be used to measure the throughput. FIG. 10 illustrates a resulting display of transaction streams, where a performance filter was applied on the transaction streams. The highlighted areas 1002 and 1004 shows throughput difference between a first model and a second model, where the difference has exceeded the amount specified by the filter.

### Functional Filter

The purpose of a functional analysis is to check for specific properties of a set of transactions. A set of predefined and configurable functional filters can be provided below:

1. Attribute Boundary Filter

Attributes and value boundaries can be specified for a particular attribute. The filter highlights all transaction attributes, which are not in the boundary specified by the user. The user can give a list of attributes and a list of boundary values. The user can also use “and” and “or” logical operators to specify attributes and combination of attributes.

2. Attribute Value Filter

The user can specify an attribute and one or more value boundaries for the specified attribute to identify.

### Accuracy Calculation

Accuracy calculation provides an overall quantitative measurement at a transaction level based on simulation results from at least two models, typically a high level model from TLM and a reference model from RTL.

There can be three types of measurements to define accuracy:

1. Timing Accuracy

Timing accuracy is a function of all timing offsets of transaction phases across two traces, the average of the offsets, the minimum, maximum, and standard deviation of the timing points as well as the percentage of its transaction duration. The result is a quantitative number. For example, a model can be said to be twenty percent accurate of the second model based on timing.

2. Performance Accuracy

Performance can mean throughput performance where throughput of the lower level model can be compared with that of the higher level model. The average difference in throughput over the length of a simulation is measured. The performance accuracy number can be a function of the various performance results of the RTL model and the TLM model. For instance, the accuracy number can be calculated according to the following formula:

Accuracy performance=100%*(1−(abs((Throughput(RTL)−Throughput(TLM)))/ Throughput(RTL)) (1)

3. Functional Accuracy

Here, the number of transactions in one model that are not represented in the other model are measured and vice versa. The functional accuracy number can be a function of the various functional analysis metrics. For instance, the functional accuracy number can be calculated according to the following formula:

Functional Accuracy=(# of lower level transaction with no representation in higher level model/# of all lower level transaction)+(# of higher level transaction with no representation in lower level models/# of all higher level transaction) (2)

### Rule Checker Generation

The rule checkers can be generated directly from the filter specification used for transaction analysis for the TL analyzer. The set of filters can be predefined, where the filters can capture the expected level of accuracy for the higher level model. Typically, rule checkers are applied to transaction traces in a batch model, or are applied in simulation real-time.

Examples for timing, sequence and performance filters used for rule checking are: illegal transaction address boundary crossings; constraints on relative transaction sequencing between separate channels (e.g., address and write data); transaction response ordering (in-order or out-of-order), depending on the field in the original transaction; legality/illegality of multiple transactions outstanding with a same ID; a max number of outstanding transactions; protocol-legal versus system-supported burst lengths; and presence/absence of master backpressure on the bus.

### Method and Process of Applying Filters and Displaying Results

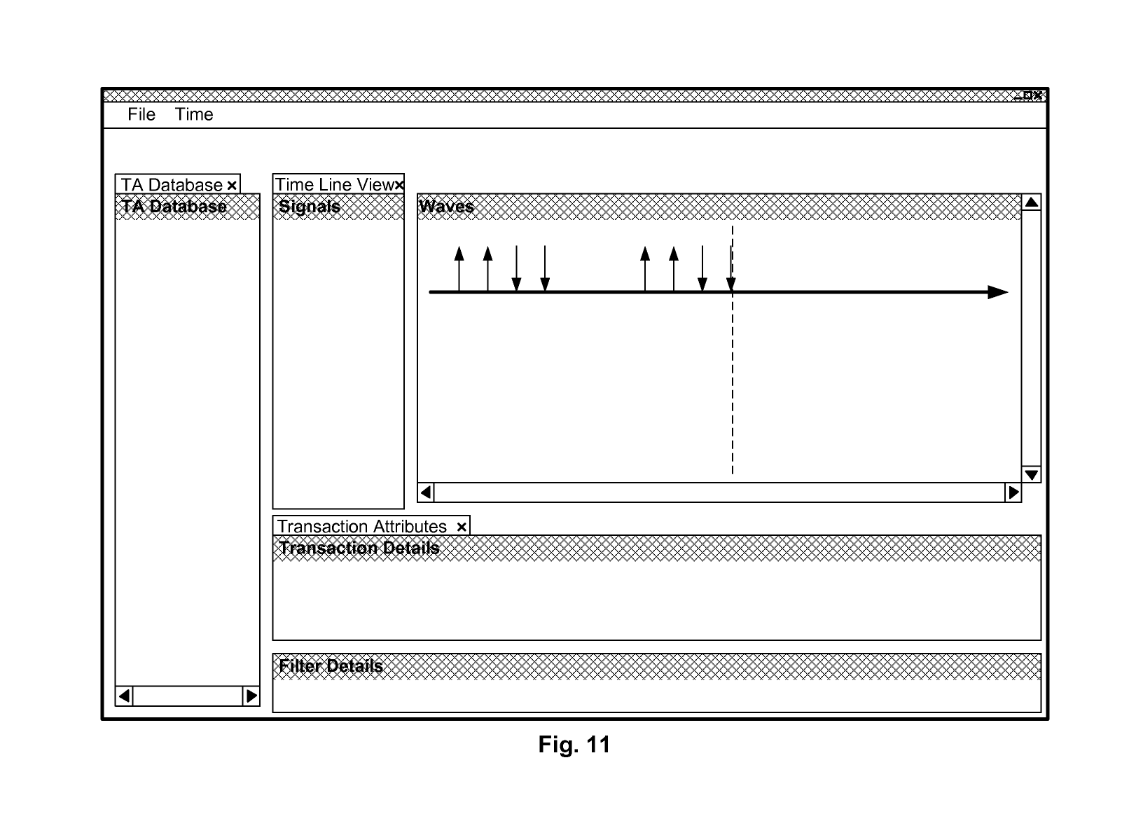

Inside a TA viewer, the following steps can be performed. First, transactions, transaction phases, associated data are displayed. FIG. 11 illustrates a user interface where a transaction stream is displayed on the user interface.

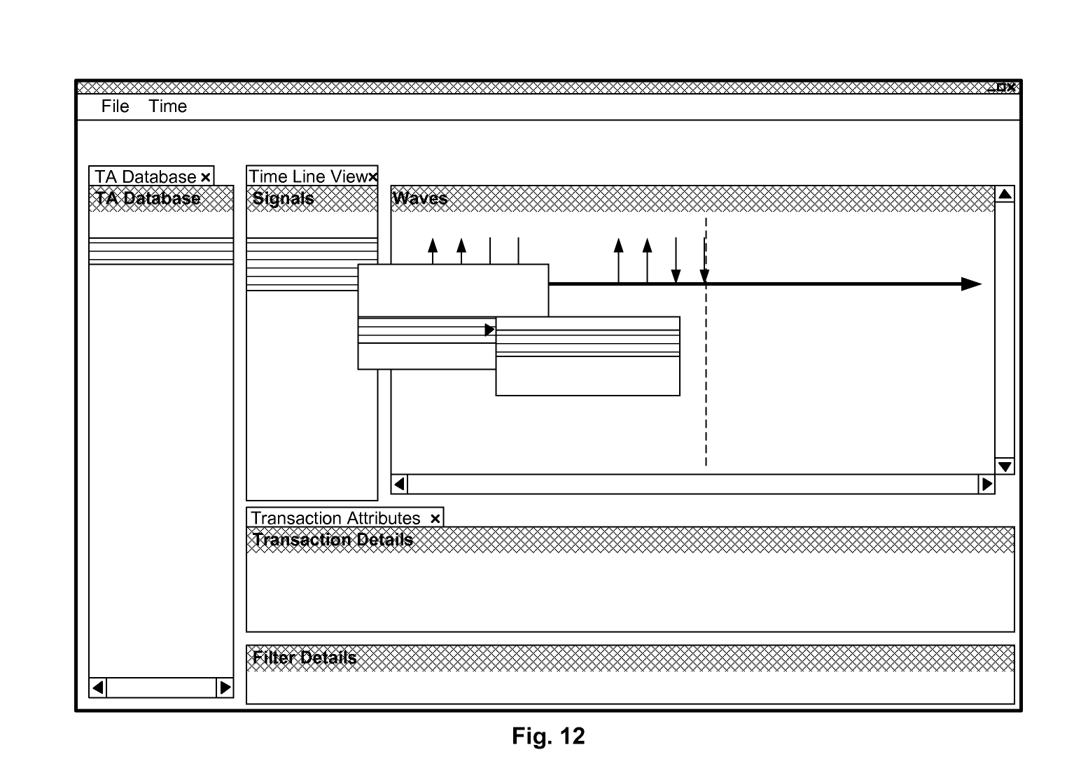

Second, one or two traces are selected to enable the application of applicable filters. A list of applicable filters can be further selected. FIG. 12 illustrates a user interface of the present invention that allows a user to select from a list of applicable filters to be applied to one or more transaction streams. A timing filter that compares each phase's timing can be applied to the selected streams, where each of the streams may represent two models.

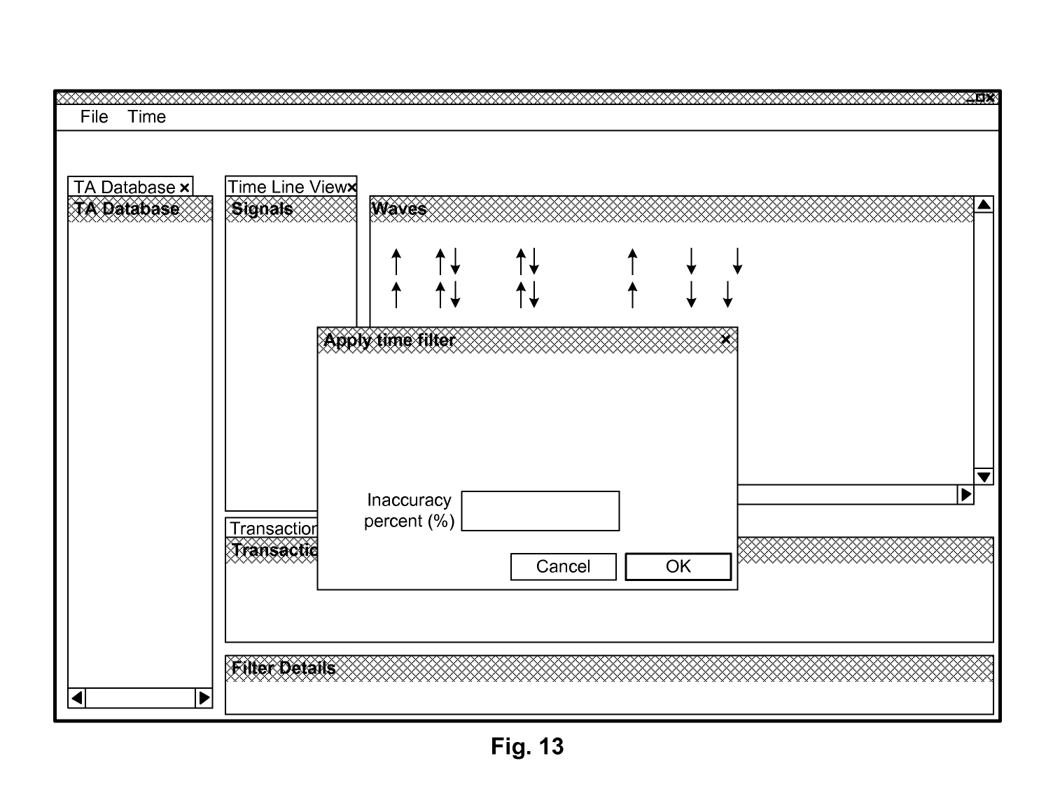

Third, if applicable, a configuration widget can be opened (i.e., displayed on the UI and capable of receiving user input) for a user to specify parameter(s) for the filter or configuring the filter. FIG. 13 illustrates a user interface of the present invention, where a configuration widget is displayed such that a user can specify parameters for a margin of difference or an inaccuracy percentage rate.

Fourth, filter execution can start after closing the configuration widget or directly from step 2, i.e. applying the filter on the selected stream(s).

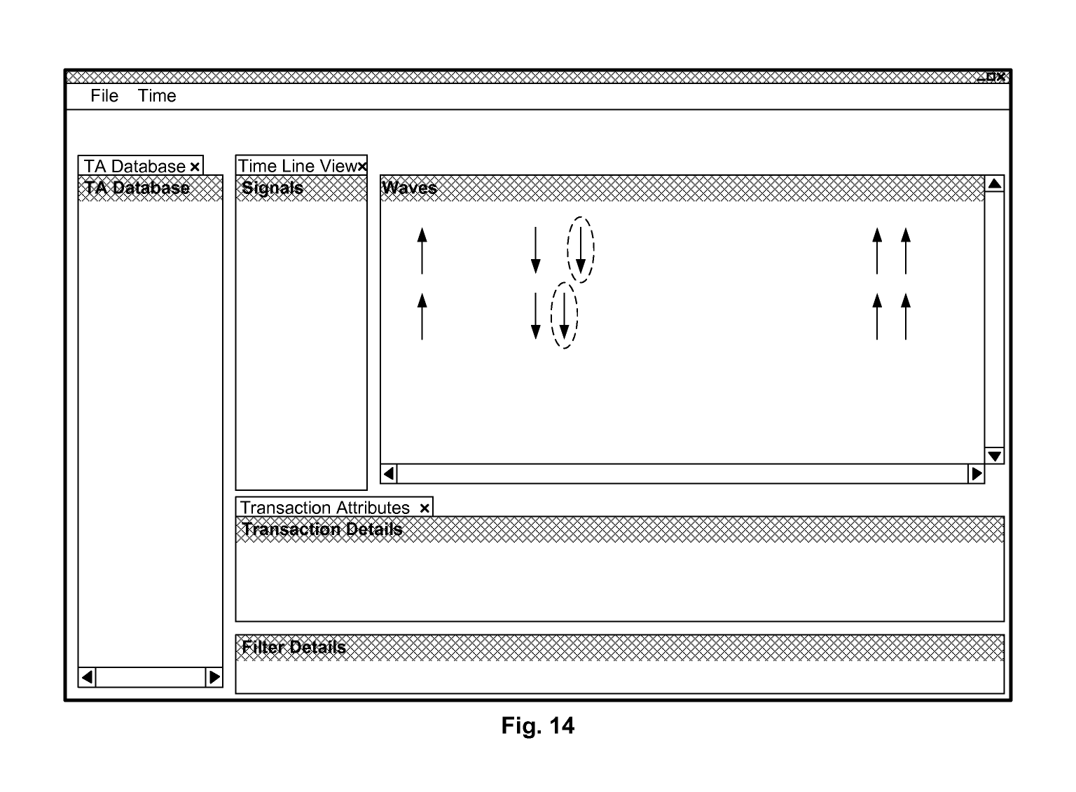

Lastly, the execution results are displayed. Any violations are highlighted on the user interface. FIG. 14 illustrates a UI, where the result is printed and the first pair of phase violations can be highlighted in circles.

While the present invention has been described with reference to certain preferred embodiments or methods, it is to be understood that the present invention is not limited to such specific embodiments or methods. Rather, it is the inventor's contention that the invention be understood and construed in its broadest meaning as reflected by the following claims. Thus, these claims are to be understood as incorporating not only the preferred methods described herein but all those other and further alterations and modifications as would be apparent to those of ordinary skilled in the art.

We claim:

1. A method for comparing a first model and a second model of an electronic design, wherein the first model is at a transaction level and the second model is at a register transfer level, comprising the steps of:
translating signal values of the second model to a transaction stream;
comparing a transaction stream of the first model against the transaction stream of the second model based on data at timing points of transaction phases of the transaction streams; and
generating results based on the comparison of the transaction streams.

2. The method of claim 1 wherein in the translating step, the translation of the signal values is configurable.

3. The method of claim 1 wherein in the translating step, data at timing points of one or more transaction phases of the transaction stream for the second model is captured and recorded.

4. The method of claim 1 wherein the translating step and the comparing step are performed during simulation run-time.

5. The method of claim 1 wherein the comparing step is performed by applying filters to the transaction streams.

6. The method of claim 1 wherein the comparing step is performed by applying timing filters that specify rules for a timing relationship of the transaction phases.

7. The method of claim 6 wherein the filters specify one or both of the following: rules of transaction phase timing stamps; and rules for all phases, first phase, last phase, first and last phases, or user specified phases.

8. The method of claim 6 wherein the filters specify a tolerance range for a timing offset between certain phases of the transaction phases.

9. The method of claim 1 wherein the comparing step is performed by applying configurable sequence filters to the transaction streams.

10. The method of claim 9 wherein the filters specify a sequence of transactions or transaction phases.

11. The method of claim 9 wherein the filters have one or more attribute values.

12. The method of claim 9 wherein the filters specify a maximum number of outstanding transactions for the transaction streams.

13. The method of claim 1 wherein the comparing step is performed by applying configurable performance filters.

14. The method of claim 13 wherein the filters specify an acceptable margin of difference in the throughput of the first model and the second model.

15. The method of claim 1 wherein the comparing step is performed by applying configurable functional filters.

16. The method of claim 15 wherein the filters specify properties of a set of transactions for the transaction streams.

17. The method of claim 1 wherein the comparing step is performed by determining an accuracy calculation, performance, and function of the first model and the second model.

18. The method of claim 17 wherein in the generating results step, a quantitative percentage number N% is generated, such that the first model is N% accurate of the second model.

19. The method of claim 17 wherein the accuracy calculation is a function of one or more of the following: a transaction phase timing; an average of phase offsets; a minimum, a maximum, and a standard deviation of timing points relative to its transaction duration; transaction throughput; a ratio of mismatched transaction numbers to all transaction numbers.

20. The method of claim 1 wherein one or more transaction streams are generated from one of the models and the streams are merged before the comparison step.

21. The method of claim 1 wherein rule checkers are selected by filters and are applied to the models during simulation run-time.

22. The method of claim 1 further comprising the steps, after the generating step, of: displaying one or more of the transaction streams on a user interface (“UI”) by plotting each of the transaction phases on a time axis; and selecting a transaction phase group to be identified on the UI.

23. The method of claim 22 wherein information of the transaction phase group is displayed, including a number of phases of the transaction, a name of the phase, a timing of the phase, an order of the phase if applicable, and additional attribute values.

24. The method of claim 22 wherein the transaction phase group is cross-referenced to its signal values and timing by drawing a connecting line to the second model.

25. A method for applying filters and displaying results for analyzing models of an electronic design, comprising the following steps:
displaying transactions, transaction phases, and associated data of the models;
selecting one or more streams to apply applicable filters, wherein a list of applicable filters for selection are selectable;
opening a configuration widget for a user to specify one or more parameters for the filter;
applying filter execution on the selected streams; and
displaying an execution result, wherein violations of the filters are identified.
